(19) United States
(12) Patent Application Publication
(10) Pub. No.: US 2021/0381776 A1
(43) Pub. Date: Dec. 9, 2021

(54) FLAT TUBE AND HEAT EXCHANGER WITH A FLAT TUBE

(71) Applicant: MAHLE International GmbH, Stuttgart (DE)

(72) Inventors: Gottfried DUERR, Ludwigsburg (DE); Matthias SEITZ, Oberkochen (DE); Achim UTZ, Waiblingen (DE)

(73) Assignee: MAHLE International GmbH, Stuttgart (DE)

(21) Appl. No.: 17/339,552

(22) Filed: Jun. 4, 2021

(30) Foreign Application Priority Data
Jun. 5, 2020 (DE) 10 2020 207 067.9

(51) Int. Cl. F28F 1/02

(52) U.S. Cl. CPC F28F 1/022; F28F 2225/04; F28F 2275/06; F28F 2255/08; F28F 2275/025; F28F 2275/12

(57) ABSTRACT

A flat tube with a wall made of a shaped first sheet metal strip which forms two fluid chambers, wherein the two fluid chambers are arranged spaced apart from one another and wherein the two fluid chambers are connected spaced apart from one another by a web wherein the flat tube has two tube ends in its tube longitudinal direction, wherein the web has a recess by means of a cutout at at least one tube end.

This nonprovisional application claims priority under 35 U.S.C. § 119(a) to German Patent Application No. 10 2020 207 067.9, which was filed in Germany on Jun. 5, 2020 and which is herein incorporated by reference.

### BACKGROUND OF THE INVENTION

### Field of the Invention

The present invention relates to a flat tube, in particular for a heat exchanger, and to a heat exchanger with at least one flat tube, in particular for a motor vehicle. The invention also relates to a method for producing a flat tube.

### Description of the Background Art

Heat exchangers with flat tubes are known in the state of the art. Thus, for example, evaporators with flat tubes are known which are inserted into openings in tube sheets of collecting tanks and are soldered tightly to the tube sheet. Extruded flat tubes are known in this regard, but they are expensive to manufacture, which leads to considerable additional costs in the case of a large number of flat tubes in a heat exchanger. Such extruded tubes have become known, for example, from DE 10 2005 052 683 B4, which corresponds to U.S. Pat. No. 7,836,944.

Folded tubes have also become known, which also still have disadvantages with regard to low-cost manufacturability; see, for example, DE 10 2004 041 101 A1.

### SUMMARY OF THE INVENTION

It is therefore an object of the present invention to provide a flat tube which can be produced simply and inexpensively. It is the object of the invention further to create a method for the efficient production of a flat tube. It is also the object to create a heat exchanger with a flat tube, a heat exchanger which is simple and inexpensive to manufacture and in which, in particular with a collecting box with a central partition, the connection between the tube and the tube sheet of the collecting box, on the one hand, and the connection of the partition in the collecting box can be sealed in a simple manner way.

An exemplary embodiment of the invention relates to a flat tube with a wall made of a shaped first sheet metal strip, which forms two fluid chambers, wherein the two fluid chambers are arranged spaced apart from one another and wherein the two fluid chambers are connected, spaced apart from one another, by a web, wherein the flat tube has two tube ends in its tube longitudinal direction, wherein the web has a recess by means of a cutout at at least one tube end. As a result, an easy-to-manufacture flat tube can be created which simultaneously forms two fluid chambers and which can be easily cut to length, wherein each fluid chamber, viewed individually, can be fitted and sealed in an opening of a tube sheet due to the cutout as a recess. In this way, a flat tube that is easy to produce can also be easily used in a collecting tank without tolerance problems even with the use of partitions.

It is advantageous if the web has a recess at both tube ends of the flat tube by means of a cutout in each case. Thus, the flat tube can be easily installed with a tube sheet at both of its tube ends, wherein both fluid chambers can be received in separate openings in the tube sheet.

It is also expedient if a rib insert is disposed in at least one of the fluid chambers or in both fluid chambers. As a result, the heat transfer between the fluid which flows in the respective fluid chamber and a fluid which flows around the fluid chamber can be optimized.

It is particularly advantageous if the at least one rib insert in one of the fluid chambers or in both fluid chambers is formed by a second sheet metal strip or that one of the two rib inserts is formed by a first second sheet metal strip and the other of the two rib inserts is formed by a second second sheet metal strip. If only one second sheet metal strip is used, a simple assembly can be carried out, whereas if two sheet metal strips are used, the second sheet metal strips can be easily produced.

It is particularly advantageous if the second sheet metal strip extends along the web from one fluid chamber to the other fluid chamber. This is advantageous if only a second sheet metal strip is used for both rib inserts in both fluid chambers. The second sheet metal strip thus also serves to stiffen the flat tube.

It is especially advantageous if the web is formed from one layer of the first sheet metal strip or from two layers of the first sheet metal strip. This is advantageous if the flat tube is formed in such a way that the closing of the sheet metal strip is carried out on one side of the web or on both sides of the web. The double layer leads to a more stable design of the flat tube.

It is also advantageous if the first sheet metal strip has two longitudinal side edges, wherein the two longitudinal side edges are connected in a sealed manner in the region of a fluid chamber. A secure seal is achieved thereby and it also allows a stable design of the flat tube. In this way, a web with two layers is advantageously achieved.

It is also especially advantageous if the first sheet metal strip has two longitudinal side edges, wherein each of the two longitudinal side edges in a central region of the first sheet metal strip adjacent to the web are connected in a sealed manner to the central region of the first sheet metal strip. This achieves a simple design with a web with only one layer.

It is also advantageous if the web is formed substantially flat. As a result, a weight-optimized design is also achieved with the lowest material cost possible.

It is also advantageous if the first sheet metal strip is prestamped and/or perforated in the region of at least one tube end and/or in the region of at least one cutout. It can be achieved thereby that the separating or cutting process is facilitated in the case of an already formed flat tube.

An exemplary embodiment of the invention also relates to a method for producing a flat tube according to the invention, wherein the first sheet metal strip is stamped or perforated before the shaping, where the cutout and/or one tube end are provided later. In this case, the method is advantageously carried out in that the first sheet metal strip is preconditioned before the shaping by stamping or perforating in order to facilitate the cutting or punching after the shaping.

It is also advantageous if the punching out of the cutout takes place after the shaping of the first sheet metal strip and/or after the closing of the two fluid chambers. In this way, the punching out is advantageously performed on the already predefined fluid chambers in order to be able to adjust the adaptation to the prefabricated fluid chambers.

It is also advantageous if the punching out of the cutout takes place after the sealing of the two fluid chambers by soldering, welding, or gluing. In this way, the punching out is advantageously performed on the already predefined and sealed fluid chambers in order to be able to adjust the adaptation to the prefabricated fluid chambers.

An exemplary embodiment of the invention relates to a heat exchanger with at least one flat tube of the invention.

It is particularly advantageous if at least one collecting tank with a tube sheet is provided, wherein the tube sheet has a series of openings, wherein a separate opening is provided for each fluid chamber of the flat tube. As a result, the tube can be fitted in such that the web does not collide with the interior of the collecting tank, because the web ends on the outside in front of the tube sheet.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic sectional illustration of an exemplary embodiment of a flat tube of the invention;

FIG. 2 shows a schematic sectional illustration of an exemplary embodiment of a flat tube of the invention;

FIG. 3 shows a schematic sectional illustration of an exemplary embodiment of a flat tube of the invention;

FIG. 4 shows a schematic sectional illustration of an exemplary embodiment of a flat tube of the invention;

FIG. 5 shows a schematic sectional illustration of an exemplary embodiment of a flat tube of the invention;

FIG. 6 shows view of a tube end of a flat tube of the invention;

FIG. 7 shows a view of a first sheet metal strip with stamping or perforation before the shaping;

FIG. 8 shows a view of a first sheet metal strip with an alternative stamping or perforation before the shaping;

FIG. 9 shows a view of a first sheet metal strip according to FIG. 8 with first indicated sections and punched-out areas; and

FIG. 10 shows a view of a first sheet metal strip according to FIG. 8 with second indicated sections and punched-out areas.

### DETAILED DESCRIPTION

FIG. 1 shows, in a sectional illustration, a first exemplary embodiment of a flat tube 1 of the invention.

Flat tube 1 is formed with a wall 2 from a shaped first sheet metal strip 3. In this case, wall 2 forms two fluid chambers 4 from first sheet metal strip 3, said chambers which are arranged adjacent to and spaced apart from one another in a width direction B of flat tube 1.

It can be seen from FIG. 1 that the two fluid chambers 4 are arranged spaced apart from one another by a web 5. Web 5 is formed by first sheet metal strip 3 and extends between the two fluid chambers 4. In this case, web 5 lies on one side of flat tube 1, as viewed in the depth direction T. Web 5 is also formed substantially flat.

In the first exemplary embodiment shown, a rib insert 6 is disposed in at least one of the fluid chambers 4, shown here, in both fluid chambers 4. In this case, one of the two rib inserts 6 is formed by a first second sheet metal strip 7 and the other of the two rib inserts 6 is formed by a second second sheet metal strip 8. Rib inserts 6 are designed in the manner of a corrugated rib and lie with their crests 9 on the inside of wall 2 and are optionally soldered there.

According to FIG. 1, the first sheet metal strip 3 has two longitudinal side edges 10, wherein each of the two longitudinal side edges 10 in a central region 11 of first sheet metal strip 3 adjacent to web 5 is connected in a sealed manner to central region 11 of first sheet metal strip 3. A longitudinal side edge 10 thus seals off a fluid chamber 4 in each case.

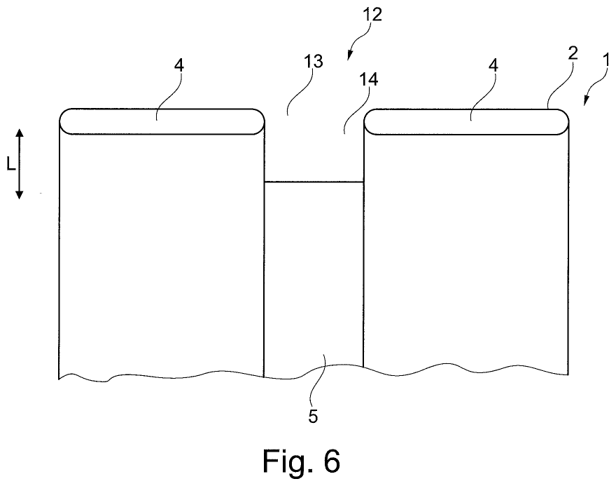

FIG. 6 shows a tube end 12 of flat tube 1 from FIG. 1 schematically. In this regard, flat tube 1 has two tube ends 12, wherein at least one of the tube ends 12 has a recess 14 on its web 5 by means of a cutout 13. This means that fluid chambers 4 protrude further in relation to web 5 in the longitudinal direction L of the tube.

Such a cutout 13 for forming a recess 14 can be provided at one of the two tube ends 12 or can be provided at both tube ends 12.

For easier production of cutout 13, first sheet metal strip 3 can be prestamped and/or perforated in the region of at least one tube end 12 and/or in the region of at least one cutout 13.

Correspondingly, in a method for producing a flat tube 1 of the invention, first sheet metal strip 3 can be stamped or perforated before the shaping, where cutout 13 and/or a tube end 12 should be provided later.

First sheet metal strip 3 can then be shaped in order to form fluid chambers 4. Optionally, fluid chambers 4 can also already be closed in a sealed manner before cutout 13 is introduced by cutting or punching. Alternatively, fluid chambers 4 can also be closed in a sealed manner only after introducing cutout 13, after cutout 13 has been introduced by cutting or punching.

It is advantageous in each case if the cutout 13 is punched out after the shaping of first sheet metal strip 3 to produce fluid chambers 4 and/or after the closing of both fluid chambers 4. This can have the advantage that cutout 13 can be punched out in a defined manner between the two fluid chambers 4, so that fluid chambers 4 can later be inserted more easily into openings without web 5 interfering therebetween.

Optionally, cutout 13 can be punched out or cut after the two fluid chambers 4 have been sealed by soldering, welding, or gluing.

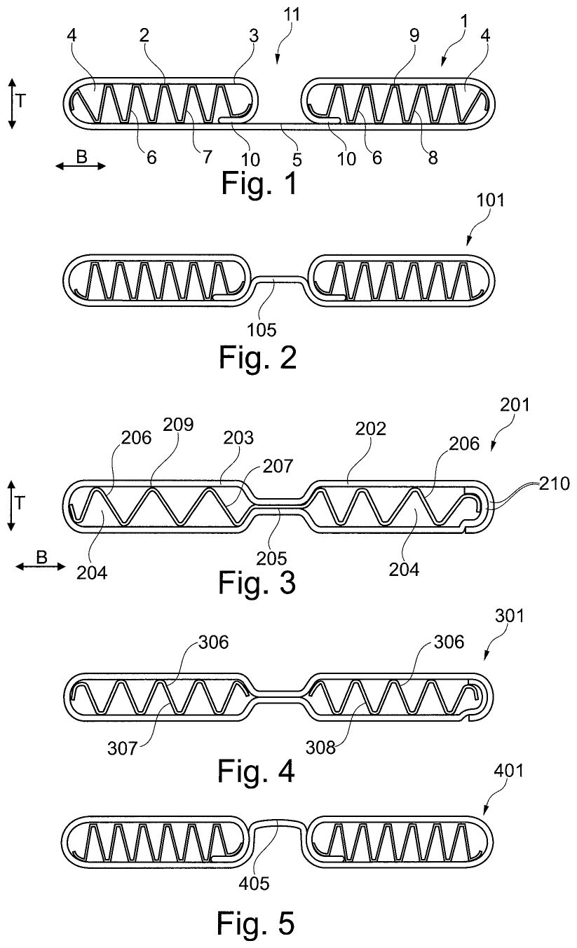

FIG. 2 shows a second exemplary embodiment of a flat tube 101 of the invention, which is designed substantially similar to flat tube 1 of FIG. 1. In contrast to flat tube 1 in FIG. 1, web 105 is arranged approximately in the center of flat tube 101 in the tube depth direction T. For this purpose, web 105 is not arranged on one side of flat tube 101, but is pulled into the center of flat tube 101, as viewed in the depth direction T.

FIG. 5 shows a second exemplary embodiment of a flat tube 401 of the invention, which is formed substantially similar to flat tube 1 of FIG. 1. In contrast to flat tube 1 in FIG. 1, web 405 is arranged pulled to an opposite side of flat tube 401 in the tube depth direction T. For this purpose, web 405 is in fact arranged on one side of flat tube 401, but web 405 is pulled above the center of flat tube 401 toward the opposite side, as viewed in the depth direction T.

FIG. 3 shows, in a sectional illustration, a third exemplary embodiment of a flat tube 201 of the invention.

Flat tube 201 is formed with a wall 202 from a shaped first sheet metal strip 203. In this case, wall 202 forms two fluid chambers 204 from first sheet metal strip 203, said chambers which are arranged adjacent to and spaced apart from one another in a width direction B of flat tube 201.

It can be seen from FIG. 3 that the two fluid chambers 204 are arranged spaced apart from one another by a web 205. Web 205 is formed by first sheet metal strip 203 and extends between the two fluid chambers 204. In this case, web 205 lies approximately in the center of flat tube 201, as viewed in the depth direction T. Web 205 is also formed substantially flat.

In the third exemplary embodiment shown, a rib insert 206 is disposed in at least one of the fluid chambers 204, shown here, in both fluid chambers 204. In this case, both rib inserts 206 are formed by a second sheet metal strip 207. Rib inserts 206 are formed in the manner of a corrugated rib and lie with their crests 209 on the inside of wall 202 and are optionally soldered there.

According to FIG. 3, web 205 is formed double-walled from two layers of first sheet metal strip 203, wherein second sheet metal strip 207 as well extends between the two layers. Second sheet metal strip 207 thus extends along web 205 from one fluid chamber 204 to the other fluid chamber 204.

According to FIG. 3, first sheet metal strip 203 has two longitudinal side edges 210, wherein each of the two longitudinal side edges 210 are connected to one another in a sealed manner in a lateral edge region of a fluid chamber 204. The two longitudinal side edges 210 thus seal off one fluid chamber 204. The other fluid chamber 204 is formed sealed by first sheet metal strip 203 and web 205.

The design of one tube end or both tube ends can then again be made in accordance with the description for FIG. 6. It is therefore referenced in this regard.

FIG. 4 shows a further fourth exemplary embodiment of a flat tube 301 of the invention. The difference to flat tube 201 of FIG. 3 is that rib inserts 306 are formed independently of one another. In this case, one of the two rib inserts 306 is formed by a first second sheet metal strip 307 and the other of the two rib inserts 306 is formed by a second second sheet metal strip 308.

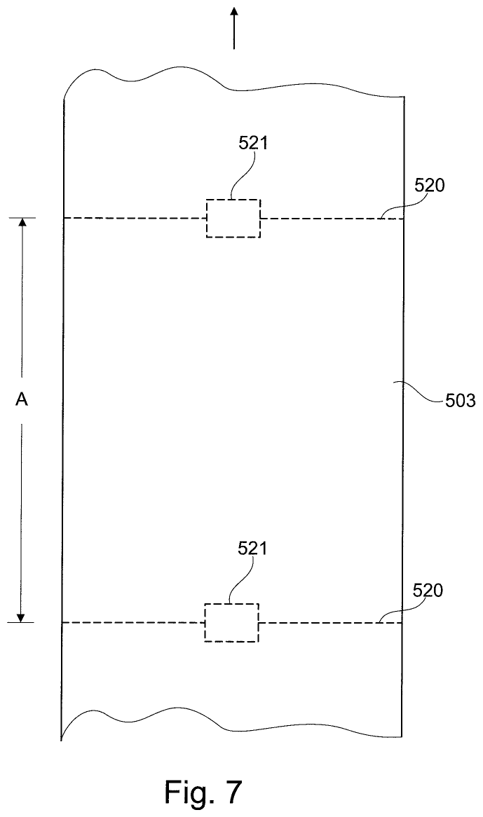

FIGS. 7 to 10 show views of a first sheet metal strip 503, 603 which, for example, is formed quasi-continuous and can be introduced and processed quasi-continuously in a shaping system; for example, it can be shaped and cut off and/or punched. For this purpose, first sheet metal strip 503 is perforated and/or stamped, where it is to be cut and/or punched out later after the shaping, see lines 520, 521. Lines 520 identify, as stamping and/or perforation, the intended position of a cut in order to cut the flat tube to length, and lines 521, as stamping and/or perforation, identify punches for forming recess 14 according to FIG. 6.

In this regard, the distance A or the position of the stampings and/or perforations 520, 521 can already be made beforehand, as required later by the length of the flat tube. In this case, the cutting or punching can also take place as a type of tearing at the prestamped or preperforated areas. The stamping or perforation thus creates something like a predetermined breaking point, which can later be used in a simplified manner for cutting or punching. This is also advantageous in order to be able to bring the punched-out area or the recess as close as possible to the curvature of the fluid chambers.

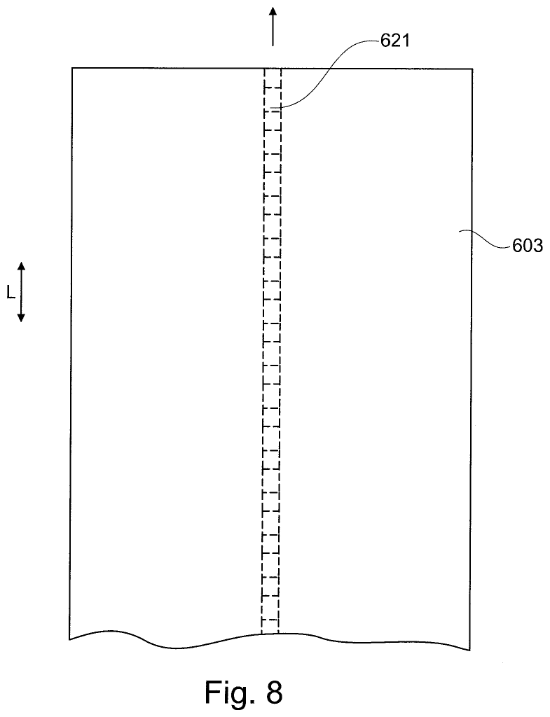

FIG. 8 shows an alternative design in which the stamping or perforation 621 is concentrated on the position of the recess and this stamping or perforation 621 extends quasi continuously or at a distance quasi continuously along the longitudinal direction L of first sheet metal strip 603.

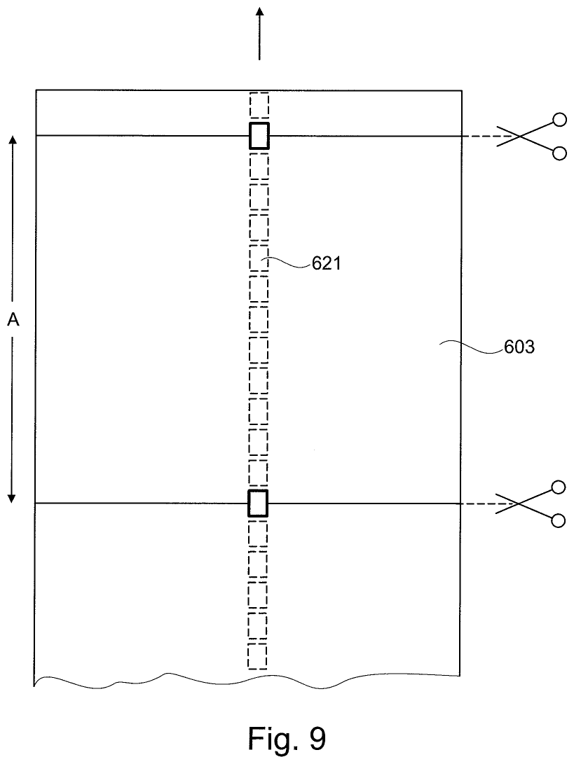

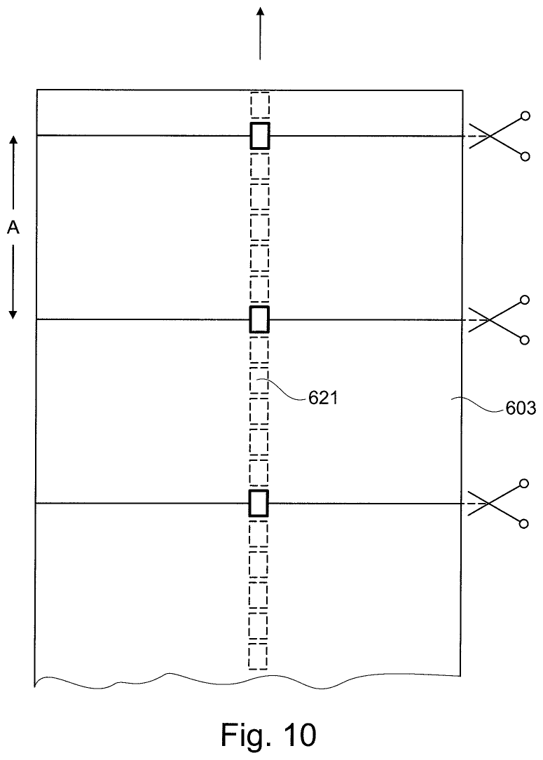

The stamping or perforation 621 can thus be used to form the recess, wherein the distance between adjacent punched-out areas for producing the recess is not specified. According to FIGS. 9 and 10, in the case of different tube lengths, the distance A can be selected differently as required and flexibly. The punched-out area then always falls accordingly into a prestamped or perforated area 621.

If such flat tubes according to the above-described FIGS. 1 to 10 are used for a heat exchanger, the tube sheet of a collecting tank can have a number of openings, wherein a separate opening is provided for each fluid chamber, in which the corresponding fluid chamber is pushed into the opening at the tube end. Accordingly, it is advantageous if double rows of openings are provided.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A flat tube comprising:
a web; and
a wall made of a shaped first sheet metal strip, which forms two fluid chambers,
wherein the two fluid chambers are arranged spaced apart from one another,
wherein the two fluid chambers are connected, spaced apart from one another, by the web,
wherein the flat tube has two tube ends in its tube longitudinal direction, and
wherein the web has a recess via a cutout at at least one tube end.

2. The flat tube according to claim 1, wherein the web has a recess at both tube ends via the cutout.

3. The flat tube according to claim 1, wherein a rib insert is disposed in at least one of the fluid chambers or in both fluid chambers.

4. The flat tube according to claim 3, wherein the at least one rib insert in one of the fluid chambers or in both fluid chambers is formed by a second sheet metal strip, or wherein one of the two rib inserts is formed by a first second sheet metal strip and the other of the two rib inserts is formed by a second second sheet metal strip.

5. The flat tube according to claim 4, wherein the second sheet metal strip extends along the web from one fluid chamber to the other fluid chamber.

6. The flat tube according to claim 1, wherein the web is formed from one layer of the first sheet metal strip or from two layers of the first sheet metal strip.

7. The flat tube according to claim 1, wherein the first sheet metal strip has two longitudinal side edges, wherein the two longitudinal side edges are connected in a sealed manner in the region of a fluid chamber.

8. The flat tube according to claim 1, wherein the first sheet metal strip has two longitudinal side edges, wherein each of the two longitudinal side edges in a central region of the first sheet metal strip adjacent to the web are connected in a sealed manner to the central region of the first sheet metal strip.

9. The flat tube according to claim 1, wherein the web is formed substantially flat.

10. The flat tube according to claim 1, wherein the first sheet metal strip is prestamped and/or perforated in the region of at least one tube end and/or in the region of at least one cutout.

11. A method for producing a flat tube according to claim 1, the method comprising:
stamping or perforarating the first sheet metal strip before shaping; and
providing the cutout and/or one tube end after the stamping or perforating.

12. The method according to claim 11, wherein the punching out of the cutout takes place after the shaping of the first sheet metal strip and/or after the closing of the two fluid chambers.

13. The method according to claim 11, wherein the punching out of the cutout takes place after the sealing of the two fluid chambers by soldering, welding, or gluing.

14. A heat exchanger comprising at least one flat tube according to claim 1.

15. The heat exchanger according to claim 14, wherein at least one collecting box with a tube sheet is provided, wherein the tube sheet has a series of openings, and wherein a separate opening is provided for each fluid chamber.
